(19) United States
(12) Patent Application Publication
(10) Pub. No.: US 2026/0343366 A1
(43) Pub. Date: Oct. 29, 2026

(54) METHOD, DEVICE AND COMPUTER STORAGE MEDIUM OF COMMUNICATION

(71) Applicant: NEC CORPORATION, Tokyo (JP)

(72) Inventors: Da WANG, Beijing (CN); Lin LIANG, Beijing (CN); Gang WANG, Beijing (CN)

(73) Assignee: NEC CORPORATION, Tokyo (JP)

(21) Appl. No.: 19/107,958

(22) PCT Filed: Sep. 16, 2022
(86) PCT No.: PCT/CN2022/119403

§ 371 Date: Feb. 28, 2025

(51) Int. Cl. H04W 36/30; H04W 24/08; H04W 76/19; H04W 88/04

(52) U.S. Cl. CPC H04W 36/305; H04W 24/08; H04W 76/19; H04W 88/04

(57) ABSTRACT

Embodiments of the present disclosure relate to methods, devices and computer readable media of communication. In one aspect, a first terminal device receives, from a network device, a configuration for a direct path between the first terminal device and the network device and an indirect path between the first terminal device and the network device via a second terminal device. If a RLF is detected for one of the direct path and the indirect path and the other of the direct path and the indirect path is available, the first terminal device transmits, to the network device via the other of the direct path and the indirect path, a first RRC message for recovery of the RLF. In this way, a network may handle a RLF properly based on an indication of RLF recovery.

### TECHNICAL FIELD

Embodiments of the present disclosure generally relate to the field of telecommunication, and in particular, to methods, devices and computer storage media of communication for multipath with relay.

### BACKGROUND

It has been proposed to support multipath (MP) with relay, where remote user equipment (UE) is connected to a network via direct and indirect paths. The direct path means that the remote UE is connected to the network directly. The indirect path means that the remote UE is connected to the network via a relay UE using PC5 interface or a non-standardized UE-UE interconnection. The support of MP with relay has a potential to improve reliability or robustness as well as throughput. However, a solution of MP with relay in control plane aspects is still incomplete and needs to be further developed.

### SUMMARY

In general, embodiments of the present disclosure provide methods, devices and computer storage media of communication for MP with relay.

In a first aspect, there is provided a method of communication. The method comprises: receiving, at a first terminal device and from a network device, a configuration for a direct path between the first terminal device and the network device and an indirect path between the first terminal device and the network device via a second terminal device; and in accordance with a determination that a radio link failure is detected for one of the direct path and the indirect path and the other of the direct path and the indirect path is available, transmitting, to the network device via the other of the direct path and the indirect path, a radio resource control message for recovery of the radio link failure, the radio resource control message indicating at least one of the following: a type of the radio link failure; measurement results associated with the first terminal device; or the one of the direct path and the indirect path that is failed.

In a second aspect, there is provided a method of communication. The method comprises: receiving, at a terminal device, an indication for activating or deactivating at least one of a direct path between the first terminal device and a network device or an indirect path between the first terminal device and the network device via a second terminal device; in accordance with a determination that the indication is to activate one of the direct path and the indirect path, performing an activating operation; and in accordance with a determination that the indication is to deactivate one of the direct path and the indirect path, performing an deactivating operation.

In a third aspect, there is provided a method of communication. The method comprises: receiving, at a first terminal device and from a network device, a configuration for a direct path between the first terminal device and the network device and an indirect path between the first terminal device and the network device via a second terminal device; and transmitting, to the network device, a request for releasing or deactivating the direct path or the indirect path.

In a fourth aspect, there is provided a device of communication. The device comprises a processor configured to cause the device to perform the method according to any of the first to third aspects of the present disclosure.

In a fifth aspect, there is provided a computer readable medium having instructions stored thereon. The instructions, when executed on at least one processor, cause the at least one processor to perform the method according to any of the first to third aspects of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which some embodiments of the present disclosure can be implemented;

FIG. 2 illustrates a diagram illustrating example bearer types for which some embodiments of the present disclosure can be implemented;

FIG. 3A illustrates an example protocol stack of a MP split data radio bearer (DRB) in which some embodiments of the present disclosure can be implemented;

FIG. 3B illustrates an example protocol stack of a MP split signaling radio bearer (SRB) in which some embodiments of the present disclosure can be implemented;

FIG. 3C illustrates another example protocol stack of a MP split DRB in which some embodiments of the present disclosure can be implemented;

FIG. 3D illustrates another example protocol stack of a MP split SRB in which some embodiments of the present disclosure can be implemented;

FIG. 4A illustrates a schematic diagram illustrating a process of communication according to embodiments of the present disclosure;

FIG. 4B illustrates a schematic diagram illustrating another process of communication according to embodiments of the present disclosure;

FIG. 4C illustrates a schematic diagram illustrating still another process of communication according to embodiments of the present disclosure;

FIG. 5 illustrates an example method of communication implemented at a first terminal device in accordance with some embodiments of the present disclosure;

FIG. 6 illustrates an example method of communication implemented at a first terminal device or a second terminal device in accordance with some embodiments of the present disclosure;

FIG. 7 illustrates an example method of communication implemented at a first terminal device in accordance with some embodiments of the present disclosure; and

FIG. 8 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPV6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2(24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In some embodiments, the terminal device may be connected with a first network device and a second network device. One of the first network device and the second network device may be a master node and the other one may be a secondary node. The first network device and the second network device may use different radio access technologies (RATs). In some embodiments, the first network device may be a first RAT device and the second network device may be a second RAT device. In some embodiments, the first RAT device is eNB and the second RAT device is gNB. Information related with different RATs may be transmitted to the terminal device from at least one of the first network device or the second network device. In some embodiments, first information may be transmitted to the terminal device from the first network device and second information may be transmitted to the terminal device from the second network device directly or via the first network device. In some embodiments, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present disclosure, the term “direct path” may be interchangeably used with “master cell group (MCG)” or “direct transmission” or “direct path transmission”, “MCG transmission” or “Uu path”. The term “indirect path” may be interchangeably used with “indirect transmission”, “indirect path transmission”, “PC5 path”, “sidelink path” or “relay path”. The term “packet duplication” may be interchangeably used with “packet data convergence protocol (PDCP) duplication”.

In the context of the present disclosure, the term “a first terminal device” may refer to a terminal device functioning as remote UE, and the term “a second terminal device” may refer to a terminal device functioning as relay UE.

Support of multi-path with relay, where a remote UE is connected to network via direct and indirect paths, has a potential to improve the reliability/robustness as well as throughput, so it needs to be considered as an enhancement area. A MP relay solution may also be utilized to for UE aggregation where UE is connected to a network via a direct path and via another UE using a non-standardized UE-UE interconnection. UE aggregation aims to provide applications requiring high uplink (UL) bitrates on 5G terminals, in cases when normal UEs are too limited by UL UE transmission power to achieve required bitrate, especially at the edge of a cell. Additionally, UE aggregation may improve reliability and stability and reduce delay of services as well. That is, if a channel condition of a terminal is deteriorating, another terminal may be used to make up for traffic performance unsteadiness caused by channel condition variation.

However, a solution of MP with relay in control plane aspects is still incomplete. For example, when a radio link failure (RLF) happens at one of the direct path and the indirect path, if the other of the direct path and the indirect path is still available, it is unclear how to recover the RLF via the other path. Further, it is unclear how to enable activation or deactivation of the direct or indirect path. In addition, when a terminal device is configured with MP with relay, the terminal device may be out of power or may not have many data to be transmitted. Maintaining the MP may cost extra power of the terminal device.

In view of this, embodiments of the present disclosure provide solutions for MP with relay so as to solve the above or other potential issues. In one aspect, a first terminal device (e.g., remote UE) receives, from a network device, a configuration for a direct path between the first terminal device and the network device and an indirect path between the first terminal device and the network device via a second terminal device (e.g., relay UE). If a RLF is detected for one of the direct path and the indirect path and the other of the direct path and the indirect path is available, the first terminal device transmits, to the network device via the other of the direct path and the indirect path, a radio resource control (RRC) message for recovery of the RLF. The RRC message indicates at least one of the following: a type of the RLF; measurement results associated with the first terminal device; or the one of the direct path and the indirect path that is failed. In this way, a network may handle a RLF properly based on an indication of RLF recovery.

In another aspect, a terminal device (e.g., remote UE or relay UE) receives an indication for activating or deactivating at least one of a direct path between a first terminal device (e.g., remote UE) and a network device or an indirect path between the first terminal device and the network device via a second terminal device (e.g., relay UE). If the indication is to activate one of the direct path and the indirect path, the first terminal device performs an activating operation. If the indication is to deactivate one of the direct path and the indirect path, the first terminal device performs a deactivating operation. In this way, activation or deactivation of a direct or indirect path may be enabled.

In still another aspect, a first terminal device (e.g., remote UE) receives, from a network device, a configuration for a direct path between the first terminal device and the network device and an indirect path between the first terminal device and the network device via a second terminal device, and transmits, to the network device, a request for releasing or deactivating the direct path or the indirect path. In this way, a terminal device may request a network to release or deactivate MP when the terminal device does not need the MP due to lack of power or data.

Principles and implementations of the present disclosure will be described in detail below with reference to the figures.

### Example of Communication Network

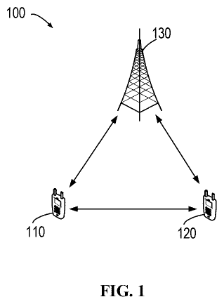

FIG. 1 illustrates a schematic diagram of an example communication network 100 in which some embodiments of the present disclosure can be implemented. As shown in FIG. 1, the communication network 100 may include a terminal device 110, a terminal device 120 and a network device 130. The network device 130 may provide one or more cells (not shown) to serve one or more terminal devices. In this example, the terminal device 110 and the terminal device 120 are served by the network device 130.

In some embodiments, the terminal device 110 and the terminal device 120 may be served by the same cell of the network device 130. In some embodiments, the terminal device 110 and the terminal device 120 may be served by different intra-frequency cells of the network device 130. In some embodiments, the terminal device 110 and the terminal device 120 may be served by different inter-frequency cells of the network device 130.

In some embodiments, the terminal device 110 may directly communicate with the network device 130 (i.e., via a direct path). The terminal device 110 may also communicate with the network device 130 via the terminal device 120 (i.e., via an indirect path). In this case, the terminal device 110 serves as remote UE, and the terminal device 120 serves as relay UE.

In some embodiments, the terminal device 120 may directly communicate with the network device 130 (i.e., via a direct path). The terminal device 120 may also communicate with the network device 130 via the terminal device 110 (i.e., via an indirect path). In this case, the terminal device 120 serves as remote UE, and the terminal device 110 serves as relay UE.

For convenience, the following description is given by taking the terminal device 110 as an example of remote UE and taking the terminal device 120 as an example of relay UE.

In some embodiments, the network device 130 and any of the terminal device 110 and the terminal device 120 may communicate with each other via an air interface (e.g., Uu interface), for example, via a wireless communication channel. The wireless communication channel may comprise a physical uplink control channel (PUCCH), a physical uplink shared channel (PUSCH), a physical random-access channel (PRACH), a physical downlink control channel (PDCCH), a physical downlink shared channel (PDSCH) and a physical broadcast channel (PBCH). Of course, any other suitable channels are also feasible.

In some embodiments, the terminal device 110 may be connected with the terminal device 120 via a sidelink (SL) interface (for example, PC5 interface or the like). In this case, the terminal device 120 serves as a Layer-2 (L2) UE-to-Network (U2N) relay. In some embodiments, the terminal device 110 and the terminal device 120 may communicate with each other via a SL channel such as a physical sidelink shared channel (PSSCH), a physical sidelink control channel (PSCCH), a physical sidelink feedback channel (PSFCH), a physical sidelink broadcast channel (PSBCH) or the like. For example, a PC5 connection may be established between the terminal device 110 and the second device 120.

In some embodiments, the terminal device 110 may be connected with the terminal device 120 via an ideal UE-UE inter-connection or backhaul connection.

It is to be understood that the number of devices in FIG. 1 is given for the purpose of illustration without suggesting any limitations to the present disclosure. The communication network 100 may include any suitable number of network devices and/or terminal devices adapted for implementing implementations of the present disclosure.

The communications in the communication network 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

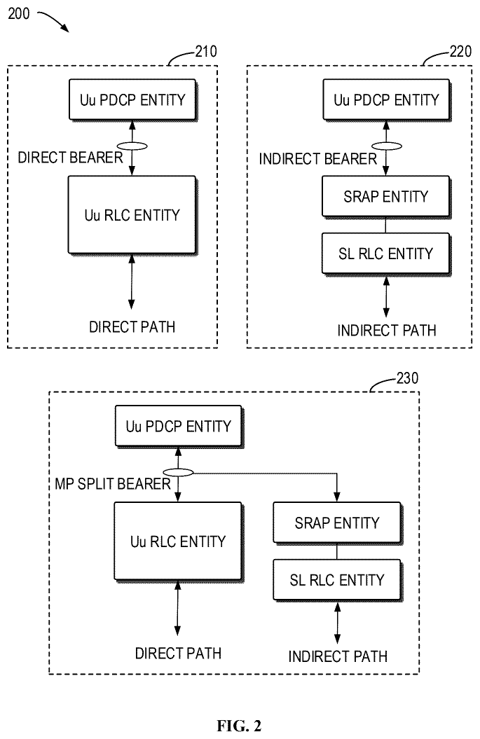

In some embodiments, a direct bearer, an indirect bearer and a MP split bearer may be supported. The direct bearer may refer to a radio bearer mapped to the direct path on an air interface (e.g., Uu interface). The indirect bearer may refer to a radio bearer mapped to the indirect path via relay UE. The MP split bearer may refer to a radio bearer mapped to both of the direct path and the indirect path based on a split bearer framework. This will be detailed in connection with FIG. 2 below.

FIG. 2 illustrates a diagram 200 illustrating example bearer types for which some embodiments of the present disclosure can be implemented. As shown by 210 in FIG. 2, a Uu PDCP entity may communicate with a Uu radio link control (RLC) entity via a direct bearer, and thus a direct bearer may be formed. As shown by 220 in FIG. 2, a Uu PDCP entity may communicate with a sidelink relay adaptation protocol (SRAP) entity and a SL RLC entity, and thus an indirect bearer may be formed. As shown by 230 in FIG. 2, a Uu PDCP entity may communicate with a Uu RLC entity via a MP split bearer and also communicate with a SRAP entity and a SL RLC entity to form a MP split bearer.

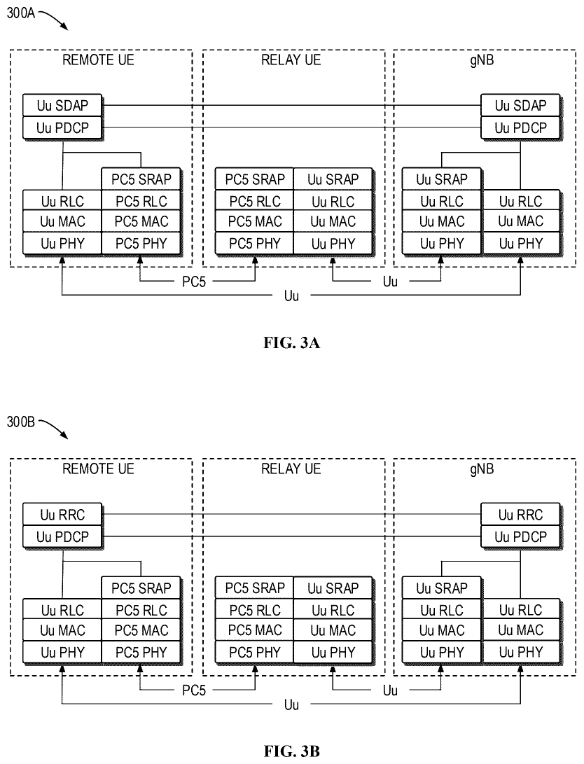

FIG. 3A illustrates an example protocol stack 300A of a MP split DRB in which some embodiments of the present disclosure can be implemented. In this example, remote UE and relay UE communicate with each other via a SL interface. For a MP split DRB, one PDCP entity at the remote UE is configured with one direct Uu RLC channel and one indirect PC5 RLC channel. For upstream, a PDCP entity delivers to a Uu RLC entity and a PC5 RLC entity with SRAP entity in the remote UE side. For downstream, a PDCP entity receives from a Uu RLC entity and a PC5 RLC entity with SRAP entity in the remote UE side.

FIG. 3B illustrates an example protocol stack 300B of a MP split SRB in which some embodiments of the present disclosure can be implemented. In this example, remote UE and relay UE communicate with each other via a SL interface. For a MP split SRB, one PDCP entity at the remote UE is configured with one direct Uu RLC channel and one indirect PC5 RLC channel. For upstream, a PDCP entity delivers to a Uu RLC entity and a PC5 RLC entity with SRAP entity in the remote UE side. For downstream, a PDCP entity receives from a Uu RLC entity and a PC5 RLC entity with SRAP entity in the remote UE side.

FIG. 3C illustrates another example protocol stack 300C of a MP split DRB in which some embodiments of the present disclosure can be implemented. In this example, remote UE and relay UE communicate with each other via an ideal UE-UE inter-connection. For a MP split DRB, one PDCP entity at the remote UE is configured with one direct Uu RLC channel and one indirect non-standard connection associated with the relay UE. For upstream, a PDCP entity delivers to a Uu RLC entity and a non-standard connection with the relay UE with SRAP entity in the remote UE side. For downstream, a PDCP entity receives from a Uu RLC entity and a non-standard connection associated with the relay UE with SRAP entity in the remote UE side.

FIG. 3D illustrates another example protocol stack 300D of a MP split SRB in which some embodiments of the present disclosure can be implemented. In this example, remote UE and relay UE communicate with each other via an ideal UE-UE inter-connection. For a MP split SRB, one PDCP entity at the remote UE is configured with one direct Uu RLC channel and one indirect non-standard connection associated with the relay UE. For upstream, a PDCP entity delivers to a Uu RLC entity and a non-standard connection associated with the relay UE with SRAP entity in the remote UE side. For downstream, a PDCP entity receives from a Uu RLC entity and a non-standard connection associated with the relay UE with SRAP entity in the remote UE side.

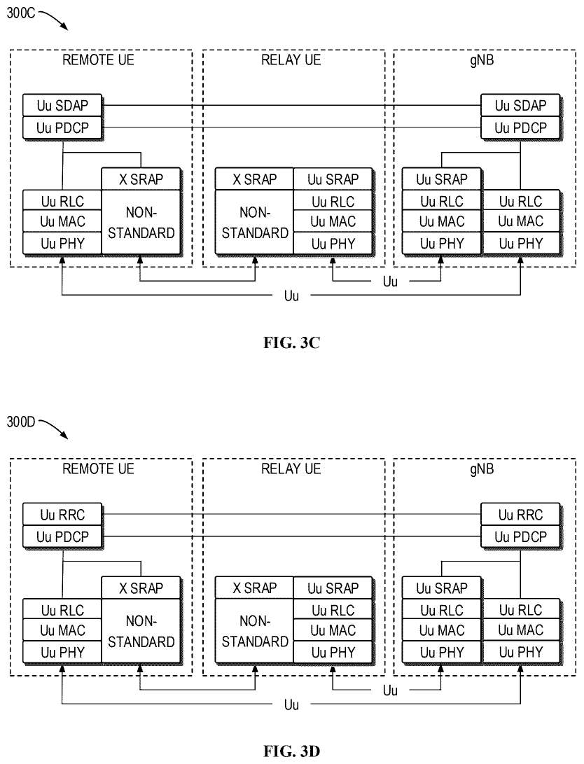

Embodiments of the present disclosure provide solutions of communication for MP with relay. Details of the solutions will be described with reference to FIGS. 4A to 4C.

### Example Implementation of RLF Handling

FIG. 4A illustrates a schematic diagram illustrating a process 400A of communication according to embodiments of the present disclosure. For the purpose of discussion, the process 400A will be described with reference to FIG. 1. The process 400A may involve the terminal device 110, the terminal device 120 and the network device 130 as illustrated in FIG. 1. It is assumed that the terminal device 110 serves as remote UE, the terminal device 120 serves as relay UE.

As shown in FIG. 4A, the network device 130 may transmit 410, to the terminal device 110, a configuration for a direct path between the terminal device 110 and the network device 130 and an indirect path between the terminal device 110 and the network device 130 via the terminal device 120. That is, the terminal device 110 is configured with MP.

Based on the configuration, the terminal device 110 may perform 411 radio link monitoring at both an air interface (e.g., Uu interface) and a sidelink interface (e.g., PC5 interface). If a RLF is detected for one of the direct path and the indirect path and the other of the direct path and the indirect path is available, the terminal device 110 may transmit 412, to the network device 130 via the other of the direct path and the indirect path, a RRC message (for convenience, also referred to as a first RRC message herein) for recovery of the RLF. In some embodiments, the RRC message may be a UEAssistanceInformation message or any other suitable messages.

Based on the indication of the RLF recovery, a network may handle the RLF properly. Some example embodiments will be described in connection with Embodiments 1 and 2 below.

### Embodiment 1

In this embodiment, the failed one of the direct path and the indirect path is the direct path.

In some embodiments, if the RLF is detected for the direct path and the indirect path is available (i.e., indirect transmission is not suspended or deactivated), the terminal device 110 may suspend the direct path. For example, the terminal device 110 may suspend direct transmission for all SRBs and DRBs. In some embodiments, the terminal device 110 may reset a medium access control (MAC) entity for the direct path (i.e. Uu MAC).

In some embodiments, the terminal device 110 may transmit the first RRC message for direct path failure recovery or report the RLF of the direct path to the network device 130 by using the indirect path/leg of MP split SRB (e.g., MP split SRB1) or indirect SRB.

In some embodiments, the first RRC message may indicate a type of the RLF/failure. In some embodiments, the type of the RLF/failure may comprise at least one of the following: T310 expiry, random access problem, RLC maximum number of retransmission reached, T312 expiry, listen before talk (LBT) failure or beam failure recovery failure. It is to be understood that any other suitable types of the RLF may also be feasible.

In some embodiments, the first RRC message may indicate measurement results associated with the terminal device 110. In some embodiments, the measurement results may comprise at least one of the following: measurement results of serving cells, measurement results of neighbor cells, measurement results of candidate L2 U2N relay UEs. It is to be understood that any other suitable measurement results may also be feasible.

In some embodiments, the first RRC message may indicate the one of the direct path and the indirect path that is failed. In this embodiment, the first RRC message may indicate the direct path.

It is to be noted that the first RRC message may indicate any combination of the above information and any other suitable information.

In some embodiments, if packet duplication is not configured for a MP split SRB (e.g., MP split SRB1) for the direct path and the indirect path and a primary path of the MP split SRB is the direct path, the terminal device 110 may set the primary path to be the indirect path.

In some embodiments, the first RRC message may be transmitted if a timer (for convenience, also referred to as a first timer herein) is not running. In some embodiments, upon transmission of the first RRC message, the terminal device 110 may start or restart the first timer.

In some embodiments, another RRC message (for convenience, also referred to as a second RRC message herein) may be received. In some embodiments, the second RRC message may be used for releasing the direct path. For example, the second RRC message may be a RRCReconfiguration message which releases the direct path. In some embodiments, the second RRC message may be used for reconfiguring the direct path. For example, the second RRC message may be a RRCReconfiguration message with reconfiguration WithSync. In some embodiments, the second RRC message may be used for releasing a connection between the terminal device 110 and the network device 130. For example, the second RRC message may be a RRCRelease message. Of course, any other suitable messages are also feasible. In these embodiments where the second RRC message is received, the terminal device 110 may stop the first timer.

In some embodiments, if the first timer expires, the terminal device 110 may initiate a RRC re-establishment procedure. In some embodiments, if the first timer expires, the terminal device 110 may release the direct path. It is to be understood that the terminal device 110 may perform any combination of the above and any other suitable operations upon expiry of the first timer.

In some embodiments, if the RLF is detected for the direct path and the indirect path is unavailable, for example, if the indirect path is suspended or deactivated, the terminal device 110 may initiate a RRC re-establishment procedure.

In this way, a RLF in a direct path may be recovered via an indirect path.

### Embodiment 2

In this embodiment, the failed one of the direct path and the indirect path is the indirect path.

In some embodiments, if the RLF is detected for the indirect path and the direct path is available (i.e., direct transmission is not suspended or deactivated), the terminal device 110 may suspend the indirect path. For example, the terminal device 110 may suspend indirect transmission for all SRBs and DRBs. In some embodiments, the terminal device 110 may reset a medium access control (MAC) entity for the indirect path (i.e. PC5 MAC).

In some embodiments, the terminal device 110 may transmit the first RRC message for indirect path failure recovery or report the RLF of the indirect path to the network device 130 by using the direct path/leg of MP split SRB (e.g., MP split SRB1) or direct SRB.

In some embodiments, the first RRC message may indicate a type of the RLF/failure. In some embodiments, the type of the RLF/failure may comprise at least one of the following: T310 expiry, random access problem, RLC maximum number of retransmission reached, T312 expiry, listen before talk (LBT) failure, beam failure recovery failure, or information of a failure in a link between the network device 130 and the terminal device 120. It is to be understood that any other suitable types of the RLF may also be feasible.

In some embodiments, the first RRC message may indicate measurement results associated with the terminal device 110. In some embodiments, the measurement results may comprise at least one of the following: measurement results of serving cells, measurement results of neighbor cells, measurement results of candidate L2 U2N relay UEs. It is to be understood that any other suitable measurement results may also be feasible.

In some embodiments, the first RRC message may indicate the one of the direct path and the indirect path that is failed. In this embodiment, the first RRC message may indicate the indirect path.

It is to be noted that the first RRC message may indicate any combination of the above information and any other suitable information.

In some embodiments, if packet duplication is not configured for a MP split SRB (e.g., MP split SRB1) for the direct path and the indirect path and a primary path of the MP split SRB is the indirect path, the terminal device 110 may set the primary path to be the direct path.

In some embodiments, the first RRC message may be transmitted if a timer (for convenience, also referred to as a second timer herein) is not running. In some embodiments, upon transmission of the RRC message, the terminal device 110 may start or restart the second timer. In some embodiments, the second timer may be the same timer as the first timer.

In some embodiments, another RRC message (for convenience, also referred to as a second RRC message herein) may be received. In some embodiments, the second RRC message may be used for releasing the indirect path. For example, the second RRC message may be a RRCReconfiguration message which releases the indirect path. In some embodiments, the second RRC message may be used for reconfiguring the indirect path. In some embodiments, the second RRC message may be used for releasing a connection between the terminal device 110 and the network device 130. For example, the second RRC message may be a RRCRelease message. Of course, any other suitable messages are also feasible. In these embodiments where the second RRC message is received, the terminal device 110 may stop the second timer.

In some embodiments, if the second timer expires, the terminal device 110 may initiate a RRC re-establishment procedure. In some embodiments, if the second timer expires, the terminal device 110 may release the indirect path. It is to be understood that the terminal device 110 may perform any combination of the above and any other suitable operations upon expiry of the second timer.

In some embodiments, if the RLF is detected for the indirect path and the direct path is unavailable, for example, if the direct path is suspended or deactivated, the terminal device 110 may initiate a RRC re-establishment procedure.

In this way, a RLF in an indirect path may be recovered via a direct path.

### Example Implementation of Indirect or Direct Path Activation or Deactivation

FIG. 4B illustrates a schematic diagram illustrating another process 400B of communication according to embodiments of the present disclosure. For the purpose of discussion, the process 400B will be described with reference to FIG. 1. The process 400B may involve the terminal device 110, the terminal device 120 and the network device 130 as illustrated in FIG. 1. It is assumed that the terminal device 110 serves as remote UE, the terminal device 120 serves as relay UE.

As shown in FIG. 4B, the network device 130 may transmit 420, to the terminal device 110, an indication for activating or deactivating at least one of a direct path between the terminal device 110 and the network device 130 or an indirect path between the terminal device 110 and the network device 130 via the terminal device 120. If the indication is to activate one of the direct path and the indirect path, the terminal device 110 may perform 430 an activating operation. If the indication is to deactivate one of the direct path and the indirect path, the terminal device 110 may perform 440 a deactivating operation. Some example embodiments will be described in connection with Embodiments 3 and 4 below.

### Embodiment 3

Continue to refer to FIG. 4B, in this embodiment, the network device 130 may transmit 421 the indication to the terminal device 110 directly.

In some embodiments, the indication may be transmitted in a RRC message and by SRB1. In some embodiments, the indication may be transmitted in a MAC control element (CE). In some embodiments, the indication may indicate that one of the direct path and the indirect path is activated and the other of the direct path and the indirect path is deactivated. In some embodiments, the indication may indicate that both of direct path and the indirect path are activated.

In some embodiments, if the indication is to activate one of the direct path and the indirect path, the terminal device 110 may resume the corresponding path for a set of radio bearers configured for the terminal device 110. For example, the terminal device 110 may resume transmission of the corresponding path for all SRBs and DRBs.

In some embodiments where the indication is to activate the direct path, if a time alignment timer is not running or a count value for beam failure indication is equal to or higher than a threshold value, the terminal device 110 may initiate a random access procedure towards a special cell (SPCell) or a primary cell (PCell) of the network device 130. In some embodiments where the indication is to activate the direct path, the terminal device 110 may resume a RLF monitoring for the direct path. In some embodiments where the indication is to activate the direct path, the terminal device 110 may activate a SPCell and a set of secondary cells (SCells) for the direct path. It is to be understood that the above operations may be performed separately or in any suitable combination when the indication is to activate the direct path.

In some embodiments where the indication is to activate the indirect path, the terminal device 110 may consider that a serving cell associated with the terminal device 120 is activated. In other words, the terminal device 110 may consider a serving cell for the indirect path is activated. In some embodiments where the indication is to activate the indirect path, the terminal device 110 may resume a RLF monitoring for the indirect path. In some embodiments where the indication is to activate the indirect path, the terminal device 110 may perform transmission over the indirect path for the terminal device 110. For example, the terminal device 110 may perform transmission over PC5 connection or ideal connection, e.g., perform transmission of a sidelink shared channel (SL-SCH) or PSCCH or PSSCH. It is to be understood that the above operations may be performed separately or in any suitable combination when the indication is to activate the indirect path.

In some embodiments, if the indication is to deactivate one of the direct path and the indirect path, the terminal device 110 may suspend the corresponding path for the set of radio bearers configured for the terminal device 110. For example, the terminal device 110 may suspend transmission of the corresponding path for all SRBs and DRBs.

In some embodiments, if the indication is to deactivate one of the direct path and the indirect path, the terminal device 110 may reset a MAC entity corresponding to the deactivated one of the direct path and the indirect path.

In some embodiments, if the indication is to deactivate one of the direct path and the indirect path, the terminal device 110 may re-establish a RLC entity of a radio bearer. In some embodiments, the radio bearer may comprise at least SRB. In some embodiments where the path to be deactivated is the indirect path, the terminal device 110 may re-establish a RLC entity of an indirect bearer. In some embodiments where the path to be deactivated is the direct path, the terminal device 110 may re-establish a RLC entity of a direct bearer.

In some embodiments, if the indication is to deactivate one of the direct path and the indirect path, the terminal device 110 may trigger discard of a PDCP service data unit (SDU) for a radio bearer. In some embodiments, the radio bearer may comprise at least SRB. In some embodiments where the path to be deactivated is the indirect path, the terminal device 110 may trigger PDCP entity of an indirect bearer to perform PDCP SDU discard. In some embodiments where the path to be deactivated is the direct path, the terminal device 110 may trigger PDCP entity of a direct bearer to perform PDCP SDU discard. In the context of the present disclosure, PDCP SDU discard means that a PDCP entity of the terminal device 110 discards all stored PDCP SDUs and PDCP protocol data units (PDUs).

In some embodiments where the indication is to deactivate the direct path, the terminal device 110 may start a time alignment timer (TAT). In some embodiments where the indication is to deactivate the direct path, the terminal device 110 may stop a RLF monitoring for the direct path. In some embodiments where the indication is to deactivate the direct path, the terminal device 110 may continue a beam failure monitoring for the direct path. In some embodiments where the indication is to deactivate the direct path, the terminal device 110 may consider that a SPCell and a set of SCells for the direct path are deactivated. It is to be understood that the above operations may be performed separately or in any suitable combination when the indication is to deactivate the direct path.

In some embodiments where the indication is to deactivate the indirect path, the terminal device 110 may disable the indirect path. That is, there is no transmission on the indirect path, e.g., there is no transmission of SL-SCH or PSCCH or PSSCH. In some embodiments where the indication is to deactivate the indirect path, the terminal device 110 may consider that a serving cell for the indirect path is deactivated. In some embodiments where the indication is to deactivate the indirect path, the terminal device 110 may suspend a RLF monitoring for the indirect path. It is to be understood that the above operations may be performed separately or in any suitable combination when the indication is to deactivate the indirect path.

In this way, a network can send an indication to remote UE to control an activated or deactivated state of a direct or indirect path.

### Embodiment 4

Still referring to FIG. 4B, in this embodiment, the network device 130 may transmit 422 an indication for activating or deactivating at least one of the direct path or the indirect path to the terminal device 120. In some embodiments, the indication may comprise an identity of the terminal device 110.

In some embodiments, the indication may be transmitted in a RRC message and by SRB1. In some embodiments, the indication may be transmitted in a MAC CE. In some embodiments, the indication may indicate that one of the direct path and the indirect path is activated and the other of the direct path and the indirect path is deactivated. In some embodiments, the indication may indicate that both of direct path and the indirect path are activated.

In some embodiments, if the indication is to activate the indirect path, the terminal device 120 may consider a serving cell associated with the terminal device 110 to be activated. In other words, the terminal device 120 may consider a serving cell for the sidelink path associated with the terminal device 110 is activated. In some embodiments, if the indication is to activate the indirect path, the terminal device 120 may perform transmission over the indirect path for the terminal device 110. For example, the terminal device 120 may perform transmission over PC5 or ideal connection for the terminal device 110, e.g., perform transmission of SL-SCH or PSCCH or PSSCH. It is to be understood that the above operations may be performed separately or in any suitable combination when the indication is to activate the indirect path.

In some embodiments, if the indication is to deactivate the indirect path, the terminal device 120 may suspend transmission over the indirect path for a set of radio bearers configured for the terminal device 110. For example, the terminal device 120 may suspend transmission for all SRBs and DRBs associated with the terminal device 110.

In some embodiments, if the indication is to deactivate the indirect path, the terminal device 120 may reset MAC entity for a sidelink interface (PC5 MAC). In some embodiments, the terminal device 120 may also reset MAC entity for an air interface (Uu MAC) associated with the terminal device 110.

In some embodiments, if the indication is to deactivate the indirect path, the terminal device 120 may re-establish a RLC entity of a radio bearer (e.g., an indirect bearer) associated with the indirect path. In some embodiments, the indirect bearer may comprise at least SRB. In some embodiments, the terminal device 120 may re-establish PC5 RLC entity and Uu RLC entity of an indirect bearer associated with the terminal device 110.

In some embodiments, if the indication is to deactivate the indirect path, the terminal device 120 may consider a serving cell associated with the terminal device 110 to be deactivated. In other words, the terminal device 120 may consider a serving cell for the sidelink path associated with the terminal device 110 is deactivated.

In some embodiments, if the indication is to deactivate the indirect path, the terminal device 120 may disable the indirect path. For example, the terminal device 120 may not perform transmission over PC5 or ideal connection for the terminal device 110, e.g., no transmission on SL-SCH or PSCCH or PSSCH for the terminal device 110.

It is to be understood that the above operations may be performed separately or in any suitable combination when the indication is to deactivate the indirect path.

Continue to refer to FIG. 4B, upon reception of the indication, the terminal device 120 may transmit 423, to the terminal device 110, a further indication for activating or deactivating the at least one of the direct path or the indirect path. In some embodiments, the further indication may be transmitted in a PC5 RRC message and by SL-SRB3. In some embodiments, the further indication may be transmitted in a MAC CE.

In some embodiments, if the further indication is to activate one of the direct path and the indirect path, the terminal device 110 may resume the corresponding path for a set of radio bearers configured for the terminal device 110. For example, the terminal device 110 may resume transmission of the corresponding path for all SRBs and DRBs.

In some embodiments where the further indication is to activate the direct path, if a time alignment timer is not running or a count value for beam failure indication is equal to or higher than a threshold value, the terminal device 110 may initiate a random access procedure towards a SPCell or a PCell of the network device 130. In some embodiments where the further indication is to activate the direct path, the terminal device 110 may resume a RLF monitoring for the direct path. In some embodiments where the indication is to activate the direct path, the terminal device 110 may activate a SPCell and a set of SCells for the direct path. It is to be understood that the above operations may be performed separately or in any suitable combination when the further indication is to activate the direct path.

In some embodiments where the further indication is to activate the indirect path, the terminal device 110 may consider that a serving cell associated with the terminal device 120 is activated. In other words, the terminal device 110 may consider a serving cell for the indirect path is activated. In some embodiments where the further indication is to activate the indirect path, the terminal device 110 may resume a RLF monitoring for the indirect path. In some embodiments where the further indication is to activate the indirect path, the terminal device 110 may perform transmission over the indirect path for the terminal device 110. For example, the terminal device 110 may perform transmission over PC5 connection or ideal connection, e.g., perform transmission of a sidelink shared channel (SL-SCH) or PSCCH or PSSCH. It is to be understood that the above operations may be performed separately or in any suitable combination when the further indication is to activate the indirect path.

In some embodiments, if the further indication is to deactivate one of the direct path and the indirect path, the terminal device 110 may suspend the corresponding path for the set of radio bearers configured for the terminal device 110. For example, the terminal device 110 may suspend transmission of the corresponding path for all SRBs and DRBs.

In some embodiments, if the further indication is to deactivate one of the direct path and the indirect path, the terminal device 110 may reset a MAC entity corresponding to the deactivated one of the direct path and the indirect path.

In some embodiments, if the further indication is to deactivate one of the direct path and the indirect path, the terminal device 110 may re-establish a RLC entity of a radio bearer. In some embodiments, the radio bearer may comprise at least SRB. In some embodiments where the path to be deactivated is the indirect path, the terminal device 110 may re-establish a RLC entity of an indirect bearer. In some embodiments where the path to be deactivated is the direct path, the terminal device 110 may re-establish a RLC entity of a direct bearer.

In some embodiments, if the further indication is to deactivate one of the direct path and the indirect path, the terminal device 110 may trigger discard of a PDCP SDU for a radio bearer. In some embodiments, the radio bearer may comprise at least SRB. In some embodiments where the path to be deactivated is the indirect path, the terminal device 110 may trigger PDCP entity of an indirect bearer to perform PDCP SDU discard. In some embodiments where the path to be deactivated is the direct path, the terminal device 110 may trigger PDCP entity of a direct bearer to perform PDCP SDU discard.

In some embodiments where the further indication is to deactivate the direct path, the terminal device 110 may start a TAT. In some embodiments where the further indication is to deactivate the direct path, the terminal device 110 may stop a RLF monitoring for the direct path. In some embodiments where the further indication is to deactivate the direct path, the terminal device 110 may continue a beam failure monitoring for the direct path. In some embodiments where the further indication is to deactivate the direct path, the terminal device 110 may consider that a SPCell and a set of SCells for the direct path are deactivated. It is to be understood that the above operations may be performed separately or in any suitable combination when the further indication is to deactivate the direct path.

In some embodiments where the further indication is to deactivate the indirect path, the terminal device 110 may disable the indirect path. That is, there is no transmission on the indirect path, e.g., there is no transmission of SL-SCH or PSCCH or PSSCH. In some embodiments where the further indication is to deactivate the indirect path, the terminal device 110 may consider that a serving cell for the indirect path is deactivated. In some embodiments where the further indication is to deactivate the indirect path, the terminal device 110 may suspend a RLF monitoring for the indirect path. It is to be understood that the above operations may be performed separately or in any suitable combination when the further indication is to deactivate the indirect path.

In this way, a network can send an indication to relay UE to control an activated or deactivated state of a direct or indirect path.

### Example Implementation of Release or Deactivation of MP

FIG. 4C illustrates a schematic diagram illustrating still another process 400C of communication according to embodiments of the present disclosure. For the purpose of discussion, the process 400C will be described with reference to FIG. 1. The process 400C may involve the terminal device 110, the terminal device 120 and the network device 130 as illustrated in FIG. 1. It is assumed that the terminal device 110 serves as remote UE, the terminal device 120 serves as relay UE.

As shown in FIG. 4C, the network device 130 may transmit 450, to the terminal device 110, a configuration for a direct path between the terminal device 110 and the network device 130 and an indirect path between the terminal device 110 and the network device 130 via the terminal device 120. That is, the terminal device 110 is configured with MP.

The terminal device 110 may transmit 451, to the network device 130, a request for releasing or deactivating the direct path or the indirect path. In some embodiments, if the terminal device 110 is out of power, the terminal device 110 may transmit the request. In some embodiments, if the terminal device 110 does not have enough data to be transmitted, the terminal device 110 may transmit the request. It is to be understood that the terminal device 110 may transmit the request in any suitable conditions, and the present disclosure does not limit this aspect. That is, after the terminal device 110 is configured with MP, the terminal device 110 may indicate release or deactivation of MP to the network device 130.

In some embodiments, the request may comprise an indication of a path to be released or deactivated. That is, the terminal device 110 may indicate the path that the terminal device 110 want to or prefer to release or deactivate, e.g., the direct path or the indirect path.

In some embodiments, the request may comprise an indication of a path to be maintained. That is, the terminal device 110 may indicate the path that the terminal device 110 want to or prefer to maintain, e.g., the direct path or the indirect path.

In some embodiments, the terminal device 110 may transmit the request via a RRC message. For example, the RRC message may be a UEAssistanceInformation message or any other suitable messages.

In some embodiments, the request may be transmitted if a timer (for convenience, also referred to as a third timer herein) is not running. In some embodiments, upon transmission of the request, the terminal device 110 may start or restart the third timer.

With the process 400C, remote UE may indicate to a network to release or deactivate MP when the remote UE does not need the MP due to lack of power or data.

It is to be understood that solutions as described in processes 400A, 400B and 400C may be used separately or in any suitable combination.

### Example Implementation of Methods

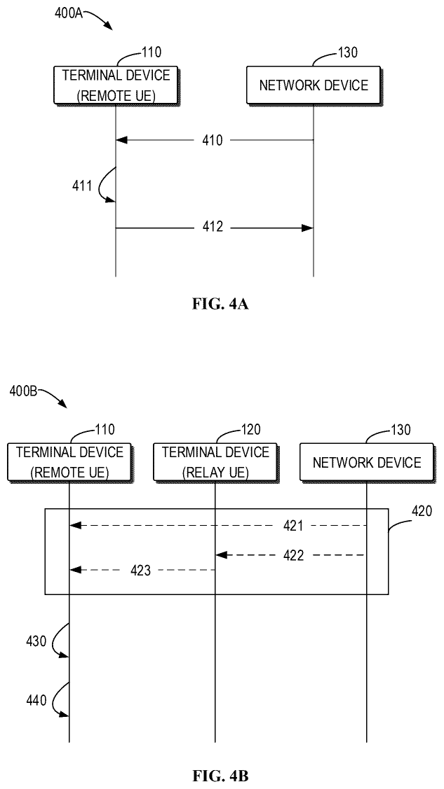

Accordingly, embodiments of the present disclosure provide methods of communication implemented at a terminal device and a network device. These methods will be described below with reference to FIGS. 5 to 7.

FIG. 5 illustrates an example method 500 of communication implemented at a first terminal device in accordance with some embodiments of the present disclosure. For example, the method 500 may be performed at the terminal device 110 as shown in FIG. 1. For the purpose of discussion, in the following, the method 500 will be described with reference to FIG. 1. It is to be understood that the method 500 may include additional blocks not shown and/or may omit some blocks as shown, and the scope of the present disclosure is not limited in this regard.

At block 510, a first terminal device (e.g., the terminal device 110) receives, from the network device 130, a configuration for a direct path between the terminal device 110 and the network device 130 and an indirect path between the terminal device 110 and the network device 130 via a second terminal device (e.g., the terminal device 120).

At block 520, the terminal device 110 determines whether a RLF is detected for one of the direct path and the indirect path and the other of the direct path and the indirect path is available. If the RLF is detected for one of the direct path and the indirect path and the other of the direct path and the indirect path is available, the method 500 proceeds to block 530.

At block 530, the terminal device 110 transmits, to the network device 130 via the other of the direct path and the indirect path, a first RRC message for recovery of the RLF. The first radio resource control message indicates at least one of the following: a type of the RLF; measurement results associated with the terminal device 110; or the one of the direct path and the indirect path that is failed.

In some embodiments where the one of the direct path and the indirect path that is failed is the indirect path, the type of the radio link failure may comprise information of a failure in a link between the network device 130 and the terminal device 120.

In some embodiments, the terminal device 110 may suspend the one of the direct path and the indirect path that is failed. In some embodiments, the terminal device 110 may reset a MAC entity for the one of the direct path and the indirect path that is failed. In some embodiments, if packet duplication is not configured for a split SRB for the direct path and the indirect path and that a primary path of the split SRB is the one of the direct path and the indirect path that is failed, the terminal device 110 may set the primary path to be the other of the direct path and the indirect path.

In some embodiments, if the first RRC message is transmitted, the terminal device 110 may start or restart a timer.

In some embodiments, if a second RRC message is received, the terminal device 110 may stop the timer. The second RRC message may be used for one of the following: releasing the one of the direct path and the indirect path that is failed; reconfiguring the one of the direct path and the indirect path that is failed; or releasing a connection between the terminal device 110 and the network device 130.

In some embodiments, if the timer expires, the terminal device 110 may perform at least one of the following: initiating a RRC re-establishment procedure; or releasing the one of the direct path and the indirect path that is failed.

In some embodiments, if the timer is not running, the terminal device 110 may transmit the first RRC message for recovery of the RLF.

With the method 500, a network may handle a RLF properly based on an indication of RLF recovery.

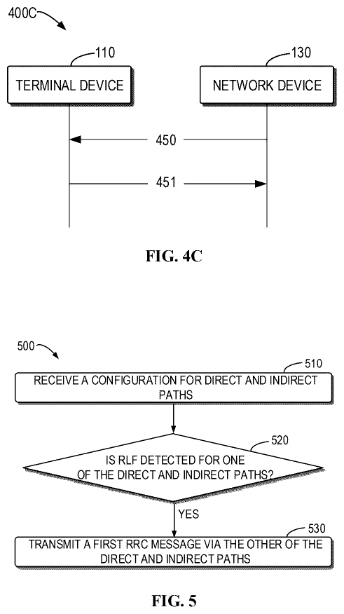

FIG. 6 illustrates an example method 600 of communication implemented at a first terminal device or a second terminal device in accordance with some embodiments of the present disclosure. For example, the method 600 may be performed at the terminal device 110 or 120 as shown in FIG. 1. For the purpose of discussion, in the following, the method 600 will be described with reference to FIG. 1. It is to be understood that the method 600 may include additional blocks not shown and/or may omit some blocks as shown, and the scope of the present disclosure is not limited in this regard.

At block 610, a terminal device (e.g., the terminal device 110 or 120) receives an indication for activating or deactivating at least one of a direct path between the first terminal device (e.g., the terminal device 110) and the network device 130 or an indirect path between the terminal device 110 and the network device 130 via the second terminal device (e.g., the terminal device 120).

At block 620, the terminal device determines whether the indication is to activate or deactivate one of the direct path and the indirect path. If the indication is to activate one of the direct path and the indirect path, the method 600 proceeds to block 630. At block 630, the terminal device performs an activating operation.

If the indication is to deactivate one of the direct path and the indirect path, the method 600 proceeds to block 640. At block 640, the terminal device performs a deactivating operation.

In some embodiments, the terminal device may be the first terminal device (e.g., remote UE). In some embodiments, the activating operation may comprise resuming an activated one of the direct path and the indirect path for a set of radio bearers configured for the first terminal device. In some embodiments, if the indication is to activate the direct path, the activating operation may comprise at least one of the following: in accordance with a determination that a time alignment timer is not running or that a count value for beam failure indication is equal to or higher than a threshold value, initiating a random access procedure towards a special cell of the network device; resuming a radio link failure monitoring for the direct path; or activating a special cell and a set of secondary cells for the direct path. In some embodiments, if the indication is to activate the indirect path, the activating operation may comprise at least one of the following: considering that a serving cell associated with the second terminal device is activated; resuming a radio link failure monitoring for the indirect path; or performing the indirect path for the first terminal device. It is to be understood that any combination of the above operations are also feasible.

In some embodiments where the terminal device is the first terminal device (e.g., remote UE), the deactivating operation may comprise at least one of the following: suspending a deactivated one of the direct path and the indirect path for a set of radio bearers configured for the first terminal device; resetting a medium access control entity corresponding to a deactivated one of the direct path and the indirect path; re-establishing a radio link control entity of a radio bearer associated with a deactivated one of the direct path and the indirect path; triggering discard of a PDCP SDU for a radio bearer associated with a deactivated one of the direct path and the indirect path. In some embodiments where the indication is to deactivate the direct path, the deactivating operation may comprise: performing at least one of the following: starting a time alignment timer; stopping a radio link failure monitoring for the direct path; continuing a beam failure monitoring for the direct path; or considering that a special cell and a set of secondary cells for the direct path are deactivated. In some embodiments where the indication is to deactivate the indirect path, the deactivating operation may comprise at least one of the following: disabling the indirect path; considering that a serving cell for the indirect path is deactivated; or suspending a radio link failure monitoring for the indirect path.

In some embodiments, the terminal device may be the second terminal device (e.g., relay UE). In some embodiments where an activated one of the direct path and the indirect path is the indirect path, the activating operation may comprise at least one of the following: considering a serving cell associated with the second terminal device to be activated; or performing the indirect path for the first terminal device. In some embodiments where a deactivated one of the direct path and the indirect path is the indirect path, the deactivating operation may comprise at least one of the following: suspending the indirect path for a set of radio bearers configured for the first terminal device; resetting at least one of medium access control entities for a sidelink interface and an air interface associated with the first terminal device; re-establishing a radio link control entity of a radio bearer associated with the indirect path; considering a serving cell associated with the second terminal device to be deactivated; or disabling the indirect path.

In some embodiments where the terminal device is the second terminal device (e.g., relay UE), the indication may comprise an identity of the first terminal device. In some embodiments where the terminal device is the second terminal device (e.g., relay UE), the second terminal device may transmit, to the first terminal device, a further indication for activating or deactivating at least one of the direct path or the indirect path.

With the method 600, activation or deactivation of a direct or indirect path may be enabled.

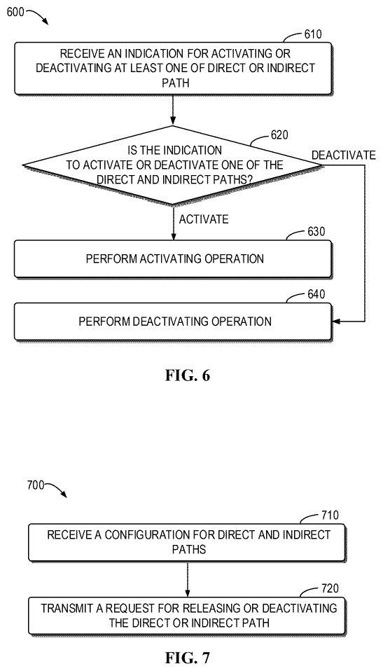

FIG. 7 illustrates an example method 700 of communication implemented at a first terminal device in accordance with some embodiments of the present disclosure. For example, the method 700 may be performed at the terminal device 110 as shown in FIG. 1. For the purpose of discussion, in the following, the method 700 will be described with reference to FIG. 1. It is to be understood that the method 700 may include additional blocks not shown and/or may omit some blocks as shown, and the scope of the present disclosure is not limited in this regard.

At block 710, a first terminal device (e.g., the terminal device 110) receives, from the network device 130, a configuration for a direct path between the terminal device 110 and the network device 130 and an indirect path between the terminal device 110 and the network device 130 via a second terminal device (e.g., the terminal device 120).

At block 720, the terminal device 110 transmits, to the network device 130, a request for releasing or deactivating the direct path or the indirect path.

In some embodiments, the request may comprise: an indication of a path to be released or deactivated; or an indication of a path to be maintained. In some embodiments, the terminal device 110 may transmit the request via a RRC message.

In some embodiments, the terminal device 110 may transmit the request if a timer is not running. In some embodiments, if the request is transmitted, the terminal device 110 may start or restart the timer.

With the method 700, a terminal device may request a network to release or deactivate MP when the terminal device does not need the MP due to lack of power or data.

It is to be understood that the operations of methods 500 to 700 are similar as that described in connection with FIGS. 4A to 4C, and thus other details are not repeated here for concise.

### Example Implementation of Devices and Apparatuses

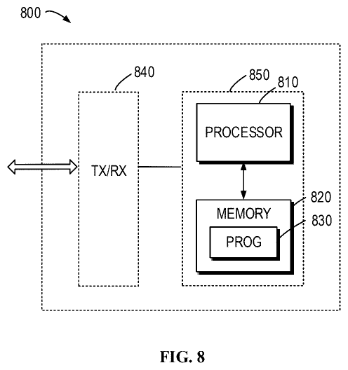

FIG. 8 is a simplified block diagram of a device 800 that is suitable for implementing embodiments of the present disclosure. The device 800 can be considered as a further example implementation of the terminal device 110 or the terminal device 120 or the network device 130 as shown in FIG. 1. Accordingly, the device 800 can be implemented at or as at least a part of the terminal device 110 or the terminal device 120 or the network device 130.

As shown, the device 800 includes a processor 810, a memory 820 coupled to the processor 810, a suitable transmitter (TX) and receiver (RX) 840 coupled to the processor 810, and a communication interface coupled to the TX/RX 840. The memory 810 stores at least a part of a program 830. The TX/RX 840 is for bidirectional communications. The TX/RX 840 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 830 is assumed to include program instructions that, when executed by the associated processor 810, enable the device 800 to operate in accordance with the embodiments of the present disclosure, as discussed herein with reference to FIGS. 1 to 7. The embodiments herein may be implemented by computer software executable by the processor 810 of the device 800, or by hardware, or by a combination of software and hardware. The processor 810 may be configured to implement various embodiments of the present disclosure. Furthermore, a combination of the processor 810 and memory 820 may form processing means 850 adapted to implement various embodiments of the present disclosure.

The memory 820 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 820 is shown in the device 800, there may be several physically distinct memory modules in the device 800. The processor 810 may be of any type suitable to the local technical network, and may include one or more of general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

In some embodiments, a first terminal device comprises a circuitry configured to: receive, from a network device, a configuration for a direct path between the first terminal device and the network device and an indirect path between the first terminal device and the network device via a second terminal device; and in accordance with a determination that a radio link failure is detected for one of the direct path and the indirect path and the other of the direct path and the indirect path is available, transmit, to the network device via the other of the direct path and the indirect path, a first radio resource control message for recovery of the radio link failure, the first radio resource control message indicating at least one of the following: a type of the radio link failure; measurement results associated with the first terminal device; or the one of the direct path and the indirect path that is failed.

In some embodiments, a first terminal device or a second terminal device comprises a circuitry configured to: receive an indication for activating or deactivating at least one of a direct path between the first terminal device and a network device or an indirect path between the first terminal device and the network device via the second terminal device; in accordance with a determination that the indication is to activate one of the direct path and the indirect path, perform an activating operation; and in accordance with a determination that the indication is to deactivate one of the direct path and the indirect path, perform a deactivating operation.

In some embodiments, a first terminal device comprises a circuitry configured to: receive, from a network device, a configuration for a direct path between the first terminal device and the network device and an indirect path between the first terminal device and the network device via a second terminal device; and transmit, to the network device, a request for releasing or deactivating the direct path or the indirect path.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 7. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-18. (canceled)

19. A method performed by a terminal device, the terminal device being configured with multi-path (MP) including a direct path and an indirect path, the method comprising
detecting a radio link failure for the indirect path; and
in a case where master cell group (MCG) transmission being not suspended, transmitting a message for the failure of the indirect path,
wherein the message includes at least one of:
a type of the failure for the indirect path; and
measurement results of candidate relay terminal devices.

20. The method of claim 19, wherein the type of the failure for the indirect path includes a Uu radio link failure of a relay terminal device on the indirect path.

21. The method of claim 19, further comprising:
resetting a sidelink specific medium access control (MAC) of a relay terminal device on the indirect path ; and
suspending indirect path transmission for all signaling radio bearers (SRBs) and data radio bearers (DRBs).

22. The method of claim 19, further comprising:
in a case where the MCG transmission being suspended, initiating a radio resource control (RRC) connection re-establishment procedure.

23. The method of claim 19, further comprising:
detecting a radio link failure for MCG; and
in a case where an indirect path transmission being not suspended, transmitting a message for the failure of the MCG.

24. The method of claim 23, wherein the transmitting of the message for the failure of the MCG comprising:
in a case where SRB1 is configured as split SRB and packet data convergence protocol (PDCP) duplication is not configured and a primary path for a PDCP entity of SRB1 refers to the direct path, setting the primary path to refer to the indirect path.

25. The method of claim 23, further comprising:
in a case where the indirect path transmission being suspended, initiating a RRC connection re-establishment procedure.

26. The method of claim 19, wherein the indirect path indicates a type of path, where data is forwarded via a relay terminal device between the terminal device and a network device.

27. The method of claim 19, wherein the candidate relay terminal devices are candidate Layer-2 (L2) user equipment (UE)-to-Network (U2N) UEs.

28. The method of claim 21, wherein the relay terminal device is a L2 U2N UE.

29. A terminal device, being configured with multi-path (MP) including a direct path and an indirect path, comprising a processor configured to:
detect a radio link failure for the indirect path; and
in a case where master cell group (MCG) transmission being not suspended, transmit a message for the failure of the indirect path,
wherein the message includes at least one of:
a type of the failure for the indirect path; and
measurement results of candidate relay terminal devices.

30. The terminal device of claim 29, wherein the type of the failure for the indirect path includes a Uu radio link failure of a relay terminal device on the indirect path.

31. The terminal device of claim 29, wherein the processor is further configured to cause the terminal device to:
reset a sidelink specific medium access control (MAC) of a relay terminal device on the indirect path; and
suspend indirect path transmission for all signaling radio bearers (SRBs) and data radio bearers (DRBs).

32. The terminal device of claim 29, wherein the processor is further configured to cause the terminal device to:
in a case where the MCG transmission being suspended, initiate a radio resource control (RRC) connection re-establishment procedure.

33. The terminal device of claim 29, wherein the processor is further configured to cause the terminal device to:
detect a radio link failure for MCG; and
in a case where an indirect path transmission being not suspended, transmit a message for the failure of the MCG.

34. The terminal device of claim 33, wherein the transmitting of the message for the failure of the MCG comprising:
in a case where SRB1 is configured as split SRB and packet data convergence protocol (PDCP) duplication is not configured and a primary path for a PDCP entity of SRB1 refers to the direct path, setting the primary path to refer to the indirect path.

35. The terminal device of claim 33, wherein the processor is further configured to cause the terminal device to:
in a case where the indirect path transmission being suspended, initiate a RRC connection re-establishment procedure.

36. The terminal device of claim 29, wherein the indirect path indicates a type of path, where data is forwarded via a relay terminal device between the terminal device and a network device.

37. The terminal device of claim 29, wherein the candidate relay terminal devices are candidate Layer-2 (L2) user equipment (UE)-to-Network (U2N) UEs.

38. The terminal device of claim 31, wherein the relay terminal device is a L2 U2N UE.
